(19) United States
(12) Patent Application Publication
(10) Pub. No.: US 2009/0296820 A1
(43) Pub. Date: Dec. 3, 2009

(54) Signal Processing Apparatus And Projection Display Apparatus

(75) Inventors: Yoshinao Hiranuma, Osaka (JP); Masutaka Inoue, Osaka (JP); Tomoya Terauchi, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/472,560

(22) Filed: May 27, 2009

(30) Foreign Application Priority Data
May 27, 2008 (JP) 2008-137810

(51) Int. Cl. H04N 11/02

(52) U.S. Cl. 375/240.16

(57) ABSTRACT

A signal processing apparatus includes: a specification unit configured to specify, based on plural pixels forming the target block, a partial region which is a part of the target block; a search-region shifting unit configured to sequentially shift, within the reference frame a search region which is compared with the partial region; a comparing unit configured to calculate a degree of coincidence between the search region and the partial region, and to specify a coincidence region which is the search region having the highest degree of coincidence with the partial region, as the search region is shifted; and a detecting unit configured to detect the motion vector of the target block based on both positions of the partial region within the target frame ad the coincidence region within the reference frame.

### CROSS REFERENCE TO RELATED APPLICATIONS

This application is based upon and claims the benefit of priority from prior Japanese Patent Application No. 2008-137810, filed on May 27, 2008; the entire contents of which are incorporated herein by reference.

### BACKGROUND OF THE INVENTION

1. Field of the Invention

The present invention relates to a signal processing apparatus and a projection display apparatus which detect a motion vector for each of plural blocks forming a target frame, on the basis of the target frame and a reference frame.

2. Description of the Related Art

There is known a technique for generating an interpolating frame inserted between a target frame and a reference frame on the basis of the target frame and the reference frame. In generating the interpolating frame, motion vectors of the target frame are detected on the basis of the target frame and the reference frame.

A block matching technique is known as one of the techniques for detecting motion vectors of the target frame. In the block matching technique, the target frame is formed of plural blocks, and a motion vector is detected for each of the plural blocks. Among the plural blocks, a block for which a motion vector should be detected will be hereinafter referred to as a target block.

Specifically, in the block matching technique, firstly, a search range within the reference frame is set on the basis of a position of the target block in the target frame. Secondly, a search block having the same shape as the target block is sequentially shifted from one block to another within the search range, and a degree of confidence of the search block with the target block is thus calculated. Thirdly, the search block having the highest degree of coincidence with the target block, namely a coincidence block, is specified. Fourthly, the motion vector of the target block is detected by an amount of deviation between the position of the target block within the target frame and a position of the coincidence block within the reference frame.

Here, in specifying the coincidence block, all of pixels forming the target block need to be compared with all of pixels forming the search block. Therefore, a processing load required for the specification of the coincidence block is large.

To reduce such a processing load, a technique is proposed in which an amount of the shifting of the search block is made larger when the search block is shifted within the search range (for example, see Japanese Patent Application Publication No. 2004-23673).

Specifically, as the search block is shifted within the search range, the search block is shifted by two pixels, whereby the number of times for shifting the search block is reduced. Thus, the number of lines for calculating the degree of coincidence is reduced, and thereby the processing load is reduced.

However, it goes without saying that, if the search block is shifted by two pixels, accuracy in detecting the motion vector is reduced as compared to a case where the search block is shifted by one pixel.

### SUMMARY OF THE INVENTION

A signal processing apparatus according to a first aspect detects a motion vector of a target block on the basis of a target frame formed of plural blocks and a reference frame referred to in detecting a motion vector, the target block being any one of the plural blocks. The signal processing apparatus includes: a specification unit (specification unit 41) configured to specify a partial region on the basis of a plurality of pixels forming the target block, the partial region being a part of the target block; a search-region shifting unit (search-region shifting unit 43) configured to sequentially shift a search region from one region to another within the reference frame, the search region being to be compared with the partial region; a comparing unit (comparing unit 44) configured to calculate a degree of coincidence of the search region with the partial region, and to specify a coincidence region which is the search region having the highest degree of coincidence with the partial region; and a detecting unit (detecting unit 45) configured to detect the motion vector of the target block on the basis of a position of the partial region within the target frame, and a position of the coincidence region within the reference frame.

According to the above aspect, the comparing unit specifies the coincidence region which is the search region having the highest degree of coincidence with the partial region. The detecting unit detects the motion vector of the target block on the basis of a position of the partial region within the target frame and a position of the coincidence region within the reference frame. The partial region is a part of the target block.

Therefore, the number of pixels compared in calculating the degree of coincidence is reduced as compared to a case where all of pixels forming the target block are compared with a of pixels forming the search block. Thereby, reduction in the processing load can be promoted. Additionally, reduction in the processing load can be promoted without reducing the number of times that the search region is shifted within the search range.

In the first aspect, the signal processing apparatus further includes a setting unit (setting unit 42) configured to set a search range within the reference fame on the basis of a position of the target block within the benchmark block. The search-region shifting unit sequentially shifts the search region from one region to another within the search range.

In the first aspect, the specification unit further includes: a candidate-region shifting unit (candidate-region shifting unit 41a) configured to sequentially shift a candidate region from one region to another within the target block, the candidate region being a candidate for the partial region; and a determining unit (determining unit 41b) configured to perform determination processing for determining whether or not to specify the candidate region as the partial region on the basis of pixels forming four corners of the candidate region, as the candidate region is shifted.

In the first aspect, the determining unit selects pixels to be used in the determination processing from the pixels forming the four corners of the candidate region, on the basis of a history of the motion vector of the target block.

In the first aspect, the specification unit further includes a candidate-region shifting unit (candidate-region shifting unit 41a) configured to sequentially shift a candidate region from one region to another within the target block, the candidate region being a candidate for the partial region; and a determining unit (determining unit 41b) configured to perform determination processing for determining whether or not to specify the candidate region as the partial region on the basis of a variance for a plurality of pixels forming the candidate region, as the candidate region is shifted.

A projection display apparatus according to a second aspect includes the signal processing apparatus according to the first aspect.

### BRIEF DESCRIPTION OF THE DRAWINGS

FIG. 1 is a block diagram showing a signal processing apparatus 100 according to a first embodiment.

FIG. 2 is a block diagram showing a motion vector detecting unit 40 according to the first embodiment.

FIG. 3 is a diagram explaining generation of an interpolating frame according to the first embodiment.

FIG. 4 is a diagram explaining shifting of a candidate region according to the first embodiment.

FIG. 5 is a diagram explaining a configuration of a partial region according to the first embodiment.

FIG. 6 is a diagram showing position of a target frame and a partial region according to the first embodiment.

FIG. 7 is a diagram explaining shifting of a search region according to the first embodiment.

FIG. 8 is a flowchart showing operations of the signal processing apparatus 100 according to the first embodiment.

FIG. 9 is a flowchart showing operations of the signal processing apparatus 100 according to the first embodiment.

FIG. 10 is a flowchart showing operations of the signal processing apparatus 100 according to the first embodiment.

FIG. 11 is a flowchart showing operations of the signal processing apparatus 100 according to the first embodiment.

FIG. 12 is a diagram explaining a method for acquiring a motion vector applied to target pixels according to the first embodiment.

### DESCRIPTION OF THE PREFERRED EMBODIMENTS

Hereinafter, a signal processing apparatus according to an embodiment of the present invention will be described with reference to the drawings. Note that, in the following description of the drawings, the same or similar portions will be denoted by the same or similar reference symbols.

However, it should be noted that the drawings are schematic and that proportions of dimensions and the like are different from actual ones. Thus, specific dimensions and the like should be determined by referring to the description below. Naturally, there are portions where relations or proportions of dimensions are different between the drawings.

### First Embodiment

### (Configuration of Signal Processing Apparatus)

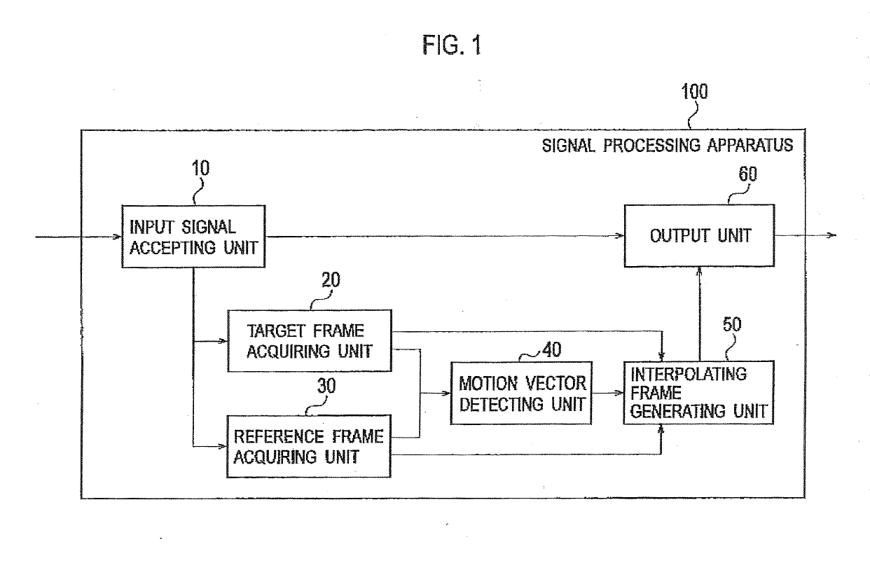

Hereinafter, a configuration of a signal processing apparatus 100 according to a first embodiment will be described with reference to a drawing. FIG. 1 is a block diagram showing the signal processing apparatus 100 according to the first embodiment It should be noted that the signal processing apparatus 100 is applied to a display apparatus such as a projection display apparatus.

As shown in FIG. 1, the signal processing apparatus 100 includes an input signal accepting unit 10, a target frame acquiring unit 20, a reference frame acquiring it 30, a motion vector detecting unit 40, an interpolating frame generating unit 50 and an output unit 60.

The input signal accepting unit 10 accepts a video input signal for each of plural pixels forming an original frame. The original frame is a frame formed of the video input signals. The video input signals include, for example, red component signals, green component signals, and blue component signals. The input signal accepting unit 10 sequentially accepts video input signals forming the respective plural original frames.

The target frame acquiring unit 20 acquires a target frame on the basis of the video input signals. The target frame is an original frame from which motion vectors are detected. The target frame is formed of plural blocks. The target frame is, for example, the n-th original frame.

The reference frame acquiring unit 30 acquires a reference frame on the basis of the video input signals. The reference frame is an original frame that is referred to in detecting the motion vectors. The reference frame is, for example, the (n+1)-th original frame.

Note that, a configuration of the reference frame may, of course, be changed in accordance with a method for detecting the motion vectors. When the motion vectors are detected by forward prediction, an original frame that comes earlier in time than the target frame is used as the reference frame. When the motion vectors are detected by backward prediction, an original frame that comes later in time than the target frame is used as the reference frame. When the motion vectors are detected by bilateral prediction, plural original frames are used as the reference frames.

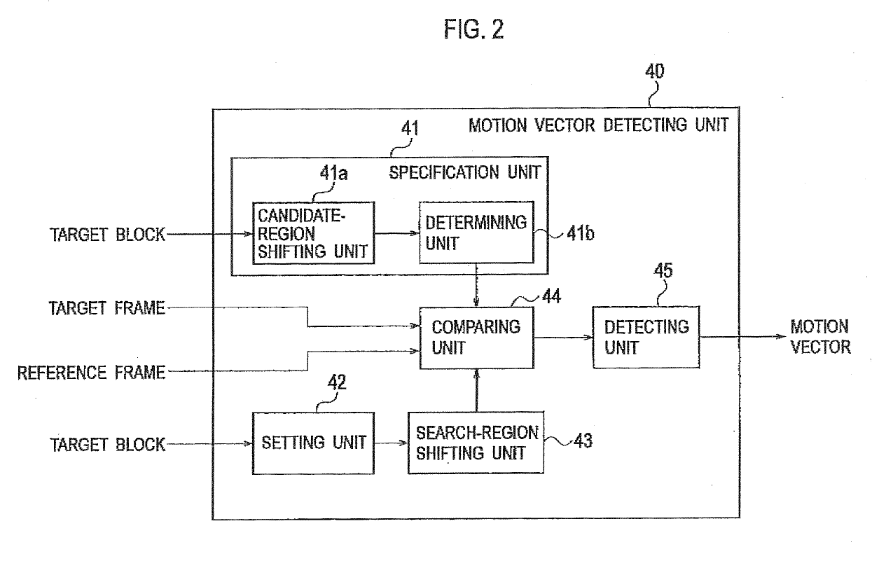

The motion vector detecting unit 40 detects the motion vectors of the target frame on the basis of the target frame and the reference frame. Specifically, after setting up a target block that is any one of plural blocks, the motion vector detecting unit 40 detects the motion vectors of the target frame. The motion vector detecting unit 40 sequentially shifts the target block from one block to another, and detects a motion vector for all blocks forming the target frame. Note that details of the motion vector detecting unit 40 will be described later (see FIG. 2).

The interpolating frame generating it 50 generates an interpolating frame inserted between the target frame and the reference frame. Specifically, on the basis of pixels forming the target frame, of pixels forming the reference frame, and of the motion vectors, the interpolating frame generating unit 50 sequentially determines pixels forming the interpolating frame.

The output unit 60 outputs video output signals in accordance with video input signals. Specifically, the output unit 60 outputs, in addition to video output signals corresponding to the original frames, video output signals corresponding to the interpolating frame inserted between the original frames. Note that the output unit 60 may have a gamma adjustment function and the like.

### (Configuration of Motion Vector Detecting Unit)

Hereinafter, a configuration of the motion vector detecting unit 40 according to the first embodiment will be described with reference to a drawing. FIG. 2 is a block diagram showing the motion vector detecting unit 40 according to the first embodiment.

A shown in FIG. 2, the motion vector detecting unit 40 includes a specification unit 41, a setting unit 42, a search-region shifting unit 43, a comparing unit 44 and a detecting unit 45.

The specification unit 41 specifies a partial region that is a part of the target block. The partial region is compared with the reference frame in detecting a motion vector. Specifically, the specification unit 41 includes a candidate-region shifting unit 41a and a determining unit 41b.

The candidate-region shifting unit 41a sequentially shifts a candidate region from one region to another within the target block, the candidate region being a candidate of the partial region. The candidate-region shifting unit 41a preferably shifts the candidate region by one pixel. The partial region is a part of the target block as has been described above.

As the candidate region is shifted, the determining unit 41b performs determination processing for determining whether or not to specify the candidate region as the partial region. Specifically, the determining unit 41b calculates a score of the candidate region on the basis of pixels forming the candidate region. Subsequently, the determining unit 41b specifies, as the partial region, the candidate region having the highest score. A calculation method shown below can be considered as a calculation method for the score.

### (Score Calculation Method 1)

The determining unit 41b calculates the score of the candidate region on the basis of pixels forming four corners of the candidate region. Here, the pixel at the upper left corner of the candidate region is denoted as a pixel A; the pixel at the upper right corner of the candidate region, a pixel B; the pixel at the lower left corner of the candidate region, a pixel C; and the pixel at the lower right corner of the candidate region, a pixel D. Specifically; the determining unit 41b acquires a luminance value Y_{A}) of the pixel A, a luminance value (Y_{B}) of the pixel B, a luminance value (Y_{C}) of the pixel C, and a luminance value (Y_{D}) of the pixel D. Subsequently, the determining unit 41b calculates the score (S) of the candidate region by S=Yₘₐₓ−Yₘᵢₙ, where: Yₘₐₓ is max (Y_{A}, Y_{B}, Y_{C}, Y_{D}); and Yₘᵢₙ is min (Y_{A}, Y_{B}, Y_{C}, Y_{D}).

### (Score Calculation Method 2)

From pixels forming four corners of the candidate region, the determining unit 41b selects pixels used in the determination processing (hereinafter, such pixels are referred to as selection pixels). The determining unit 41b calculates the score of the candidate region on the basis of the selection pixels. Specifically the determining unit 41b acquires a motion vector history of the target block. For example, in a case where the target frame is the n-th original frame, the determining unit 41b acquires, as the motion vector history of the target block, a motion vector detected when the (n−1)-th original frame is set to the target frame. Subsequently, the determining unit 41b selects the selection pixels on the basis of the history of the motion vector of the target block.

Firstly, if the motion vector history of the target block is not more than a predetermined threshold value, the determining unit 41b selects the pixels A to D as the selection pixels. The determining unit 41b calculates the score (S) of the candidate region by S=Yₘₐₓ−Yₘᵢₙ.

Secondly, when the motion vector history of the target block is horizontal, the determining unit 41b selects the pixels A to D as the selection pixels. The determining unit 41b calculates the score (S) of the candidate region by S=|Y_{A}−Y_{B}|+|Y_{C}−Y_{D}|.

Thirdly, when the motion vector history of the target block is vertical, the determining unit 41b selects the pixels A to D as the selection pixels. The determining unit 41b calculates the score (S) of the candidate region by S=|Y_{A}−Y_{C}|+Y_{B}−Y_{D}|.

Fourthly, when motion vector history of the target block is diagonal (slopes down to the left or to the right), the determining unit 41b selects the pixels B and C as the selection pixels. The determining unit 41b calculates the score (S) of the candidate region by S=|Y_{B}−Y_{C}|.

Fifthly, if the motion vector history of the target block is diagonal (slopes up to the left or to the right), the determining unit 41b selects the pixels, B and C as the selection pixels. The determining unit 41b calculates the score (S) of the candidate region by S=|Y_{A}−Y_{D}|.

### (Score Calculation Method 3)

The determining unit 41b calculates the score of the candidate region on the basis of all of the pixels forming the candidate region. Specifically, the determining unit 41b acquires luminance values (Y_{1,1)}, Y_{(1,2)}, . . . Y_{(m,n)}) of all of the pixels forming the candidate region. Subsequently, the determining unit 41b calculates an average luminance value (A) of all of the pixels by the following equation.

$$A = \frac{1}{m \times n} {\sum }_{i = 1 , j = 1}^{i = m , j = n} {Y}_{i , j} \qquad [ Equation 1 ]$$

Furthermore, the determining it 41b calculates the score of the candidate region by the following equation.

$$S = {\sum }_{i = 1 , j = 1}^{i = m , j = n} {( A - {Y}_{i , j} )}^{2} \qquad [ Equation 2 ]$$

In other words, the determining unit 41b calculates, as the score of the candidate region, a variance for all of the pixels forming the candidate region.

The setting unit 42 sets a search range within the reference frame. Specifically, on the basis of a position of the target block within the benchmark block, the setting unit 42 specifies, within the reference frame, a position (coordinates) corresponding to the target block. Subsequently, within the reference frame, the setting it 42 sets, as the search range, a region surrounding a position (coordinates) corresponding to the target block. The search range is a range larger than the target block.

The searched-region shifter 43 sequentially shifts a searched region from one region to another within the reference frame, the searched region being to be compared with the target block. Specifically, the searched-region shifter 43 sequentially shifts the searched region from one region to another within the searched range. The search-region shifting unit 43 preferably shifts the search region by one pixel. The search region preferably has substantially the same shape as the partial region.

The comparing unit 44 calculates a degree of coincidence between the search region and the partial region as the search region is shifted. The comparing unit 44 specifies, as a coincidence region, the search region having the highest degree of coincidence with the partial region. Specifically, after superimposing the search region on the partial region, the comparing unit 44 acquires absolute values of differences in pixels between the partial region and the search region having the same positions (same coordinates) as those of the partial region. Subsequently, the comparing unit 44 calculates the sum of the absolute values of the differences (difference absolute-value sum) for all of the pixels forming the partial region. The comparing unit 44 specifies, as the coincidence region, the search region having the smallest difference absolute-value sum.

The detecting unit 45 detects a motion vector of the target block on the basis of a position (coordinates) of the partial region within the target frame, and a position (coordinates) of the coincidence region within the reference frame. Specifically, the detecting unit 45 detects the motion vector of the target block on the basis of an amount of deviation between the position (coordinates) of the partial region and the position (coordinates) of the coincidence region.

### (Generation of Interpolating Frame)

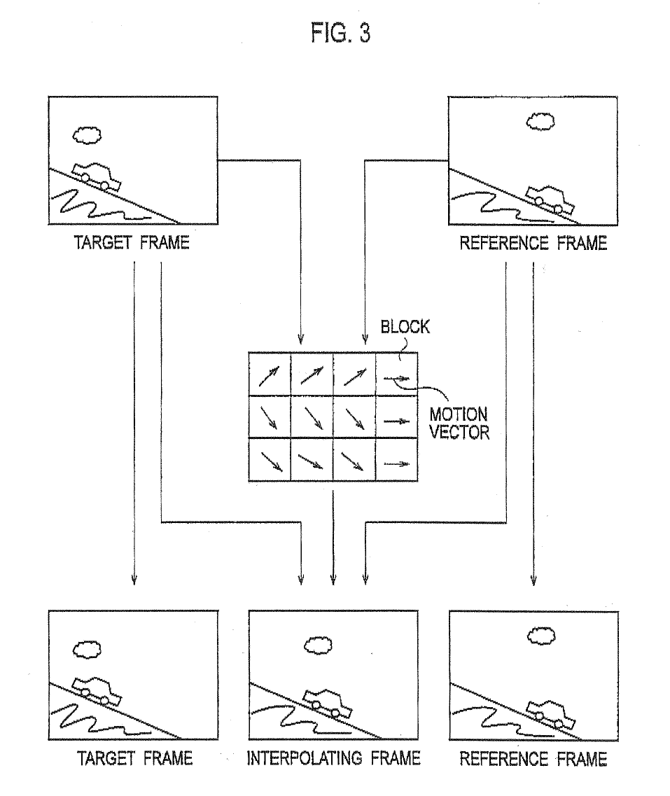

Hereinafter, generation of an interpolating frame according to the first embodiment will be described with reference to a drawing. FIG. 3 is a diagram explaining the generation of the interpolating frame according to the first embodiment.

As shown in FIG. 3, a motion vector is detected on the basis of the target frame and reference frame for each of plural blocks forming the target frame. Subsequently, the interpolating frame is generated on the basis of the target frame, the reference frame, and the motion vectors.

### (Shifting of Candidate Region)

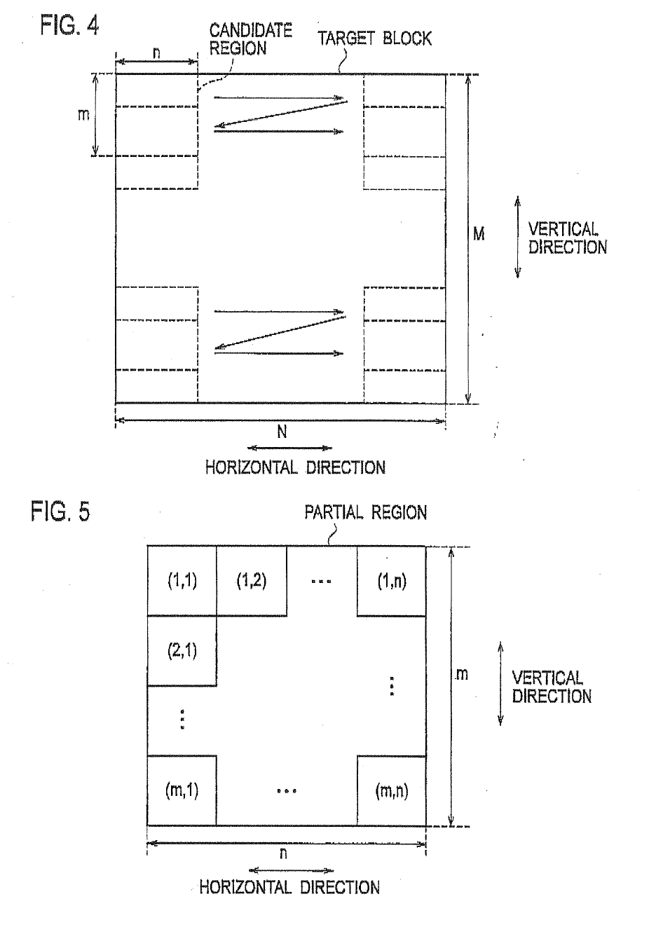

Hereinafter, the shifting of the candidate region according to the first embodiment will be described with reference to a drawing. FIG. 4 is a diagram explaining the shifting of the candidate region according to the first embodiment.

As shown in FIG. 4, the target block includes M pixels vertically, and N pixels horizontally. In other words, the target block has a rectangular shape of M by N pixels. The candidate region includes m pixels vertically, and n pixels horizontally. In other words, the candidate region has a rectangular shape of m by n pixels. Note that inequalities M>m and N>n hold here. The candidate region is sequentially is shifted within the target block. For example, the candidate region is preferably shifted by one pixel.

### (Configuration of Partial Region)

Hereinafter, the partial region according to the first embodiment will be described with reference to a drawing. FIG. 5 is a diagram explaining the partial region according to the first embodiment.

As has been described above, the partial region is the candidate region having the highest score (S). Therefore, as shown in FIG. 5, the partial region includes m pixels vertically, and n pixels horizontally. In other words, the partial region has a rectangular shape of m by n pixels.

### (Positions of Target Block and Partial Region)

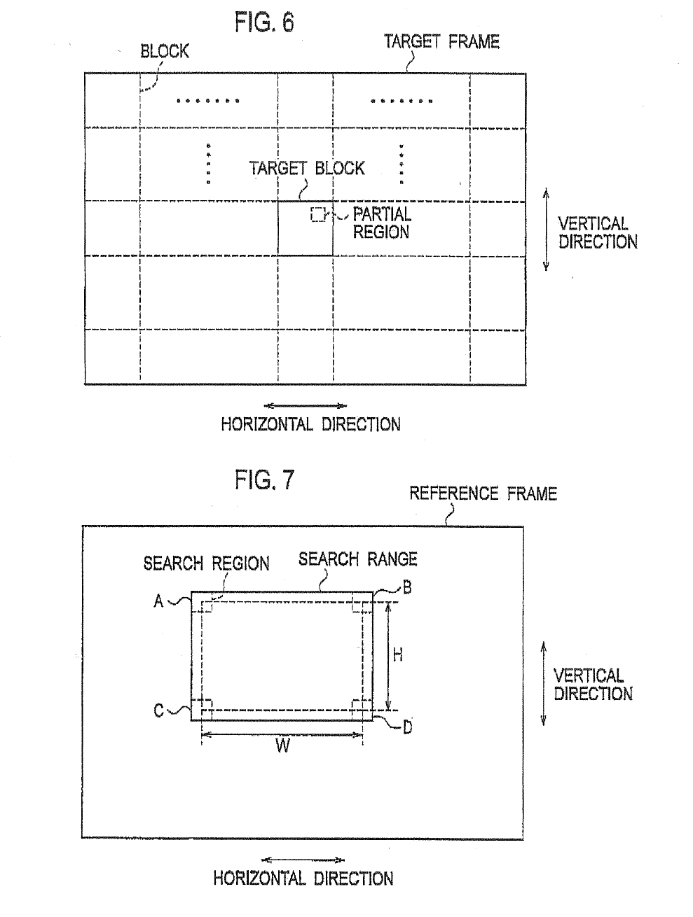

Hereinafter, positions of the target block and the partial region according to the first embodiment will be described with reference to a drawing. FIG. 6 is a diagram showing the positions of the target frame and the partial region according to the first embodiment.

As shown in FIG. 4, the target block is any one of the plural blocks forming the target frame. Positions of the respective plural blocks axe predetermined. As has been described above, the target block is shifted from one block to another within the reference frame.

The partial region is, as has been described. above, a part of the target block. The position of the partial region within the target block is determined in accordance with the score (S).

### (Shifting of Search Region)

Hereinafter, the shifting of the search region according to the first embodiment will be described with reference to a drawing. FIG. 7 is a diagram explaining the shifting of the search region according to the first embodiment.

As shown in FIG. 7, the searched range is set within the reference frame. The searched region is sequentially shifted from one region to another within the search range. Here, the search region is preferably shifted by one pixel. A range of the shifting within the search range has a width W horizontally, and a height H vertically. In other words, the range of the shifting within the search range is a range connecting the centers of the search regions that are located in an upper left position A, an upper right position B, a lower left position C, and a lower right position D.

### (Operations of Signal Processing Apparatus)

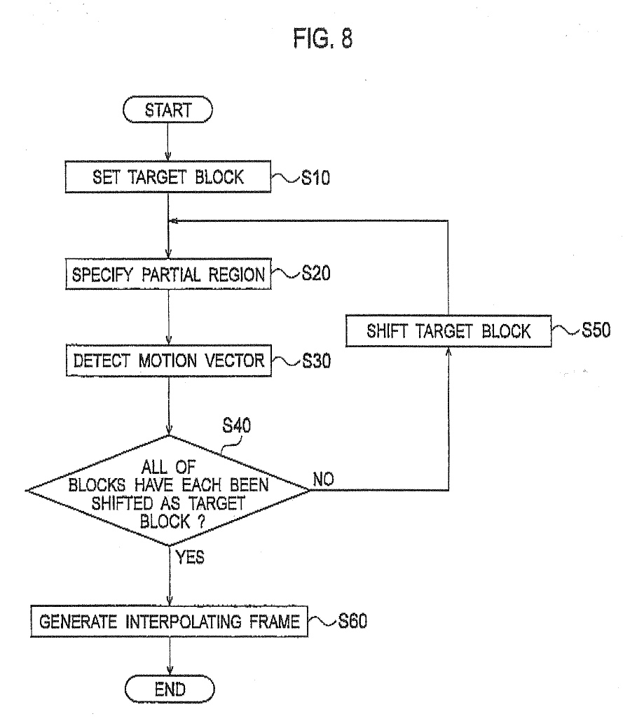

Hereinafter, operations of a signal processing apparatus according to the fast embodiment will be described with reference to a drawing. FIG. 8 is a flowchart showing the operations of a signal processing apparatus 100 according to the first embodiment.

As shown in FIG. 8, in step 10, the signal processing apparatus 100 sets, as the target block, any one block out of the plural blocks forming the target frame. For example, the signal processing apparatus 100 sets an upper left block as the target block.

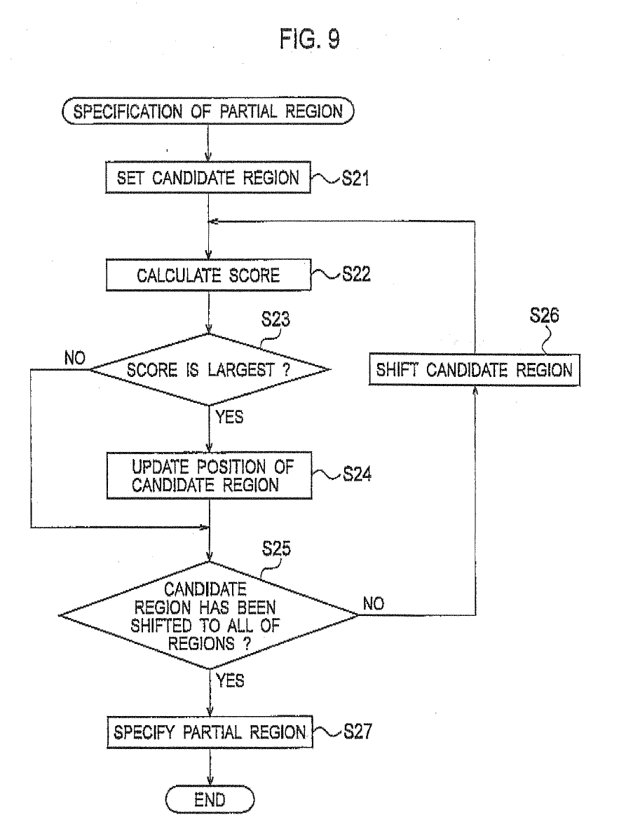

In step 20, on the basis of plural pixels forming the target block, the signal processing apparatus 100 specifies the partial region that is a part of the target block. Details of the specification of the partial region will be described later (see FIG. 9).

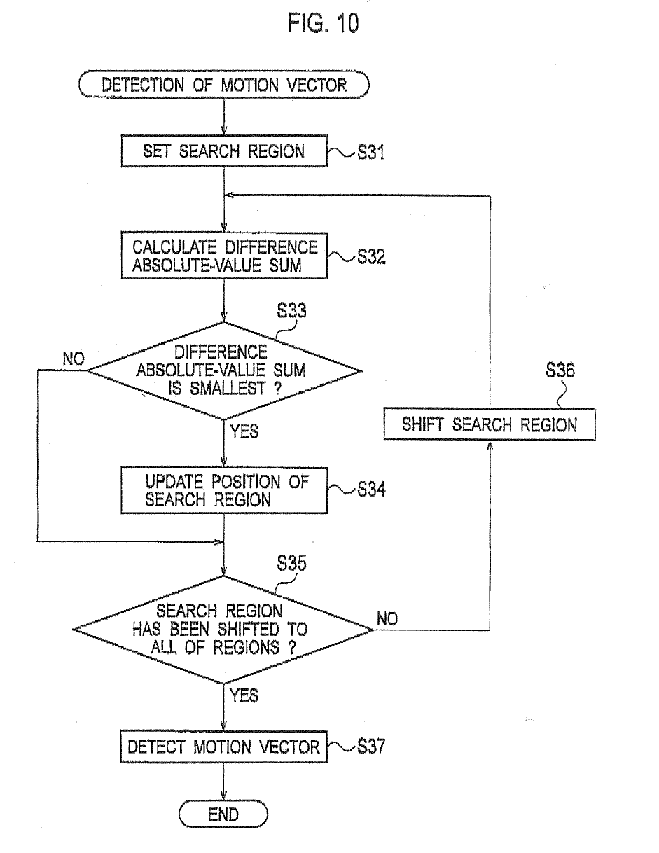

In step 30, the signal processing apparatus 100 detects the motion vector of the target block. Details of the detection of the motion vector will be described later (see FIG. 10).

In step 40, the signal processing apparatus 100 determines whether or not all of the blocks forming the target frame have each been set as the target block. The signal processing apparatus 100 proceeds to processing in step 50 if all of the blocks have not yet each been set as the target block. The signal processing apparatus 100 proceeds to processing m step 60 if all of the blocks have each been set as the target block.

In step 50, the signal processing apparatus 100 shifts the target block from one block to another.

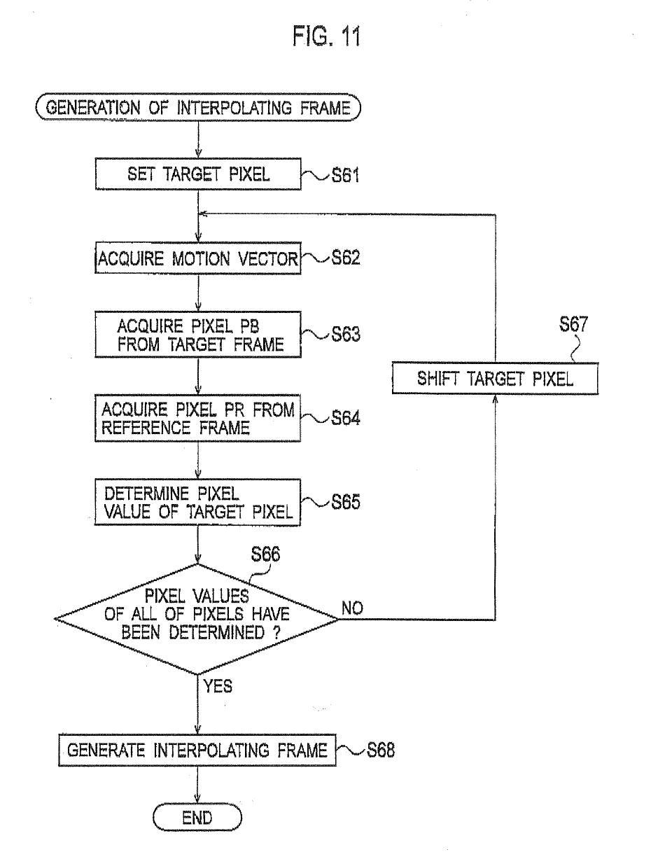

In step 60, on the basis of the target frame, the reference frame and the motion vectors, the signal processing apparatus 100 generates an interpolating frame inserted between the target frame and reference frame. Details of the generation of the interpolating frame will be described later (see FIG. 11).

### (Specification of Partial Region)

Hereinafter, details of the above-mentioned specification of the partial region will be described with reference to FIG. 9. FIG. 9 is a flowchart showing details of the above-mentioned specification of the partial region.

As shown in FIG. 9, in step 21, the signal processing apparatus 100 sets a candidate region in the target block. For example, the signal processing apparatus 100 sets the candidate region in an upper left position of the target block.

In step 22, the signal processing apparatus 100 calculates the score (S) of the candidate region. As has been described above, any one of the score calculation methods 1 to 3 can be considered as a calculation method for calculating the score (S).

In step 23, the signal processing apparatus 100 determines whether or not the score (S) of the candidate region is the largest. Note that an initial value of the score (S) is 0. The signal processing apparatus 100 proceeds to processing in step 24 if the score (S) of the candidate region is the largest. The signal processing apparatus 100 proceeds to processing in step 25 if the score (S) of the candidate region is not the largest.

In step 24, the signal processing apparatus 100 updates a position (coordinates) of the candidate region as the position (coordinates) of the partial region.

In step 25, the signal processing apparatus 100 determines whether or not the candidate region has been shifted to all of the regions forming the target block. The signal processing apparatus 100 proceeds to processing in step 26 if the candidate region has not yet been shifted to all of the regions. The signal processing apparatus 100 proceeds to processing in step 27 if the candidate region has been shifted to all of the regions.

In step 26, the signal processing apparatus 100 shifts the candidate region within the target block. The signal processing apparatus 100 preferably shifts the candidate region by one pixel.

In step 27, the signal processing apparatus 100 specifies, as the partial region, the candidate region having the highest score (S). In other words, the signal processing apparatus 100 specifies the position (coordinates) of the partial region within the target block by using the position (coordinates) finally updated in stop 24.

### (Detection of Motion Vectors)

Hereinafter, details of the above-mentioned detection of the motion vectors will be described with reference to FIG. 10. FIG. 10 is a flowchart showing details of the above-mentioned detection of the motion vectors.

As shown in FIG. 10, in step 31, the signal processing apparatus 100 sets the search region within the search range. For example, the signal processing apparatus 100 sets the search region in an upper left position of the search range.

In step 32, the signal processing apparatus 100 firstly superimposes the partial region on the search region, and then acquires absolute values of differences in pixels between the partial region and tie search region. Subsequently, the signal processing apparatus 100 calculates the sum of the absolute values of the differences (difference absolute-value sum) for all of the pixels forming the partial region.

In step 33, the signal processing apparatus 100 determines whether or not the difference absolute-value sum is the smallest. Note that an initial value of the difference absolute-value sum is the largest value of the difference absolute-value gum. The signal processing apparatus 100 proceeds to processing in step 34 if the difference absolute-value sum is the smallest. The signal processing apparatus 100 proceeds to processing in step 35 if the difference absolute-value sum is not the smallest.

In step 34, the signal processing apparatus 100 updates a position (coordinates) of the coincidence region as the position (coordinates) of the search region. The coincidence region is, as has been described above, used in the detection of the motion vector.

In step 35, the signal processing apparatus 100 determines whether or not the search region has been shifted to all of the regions forming the search range. The signal processing apparatus 100 proceeds to processing in step 36 if the search region has not yet been shied to al of the regions. The signal processing apparatus 100 proceeds to processing in step 37 if the search region has been shifted to all of the regions.

In step 36, the signal processing apparatus 100 shifts the search region within the search range. The signal processing apparatus 100 preferably shifts the search region by one pixel.

In step 37, the signal processing apparatus 100 specifies, as the coincidence region, the search region having the smallest difference absolute-value sum. In other words, the signal processing apparatus 100 specifies the position (coordinates) of the coincidence region within the search range (reference frame) by the position (coordinates) finally updated in step 34.

Subsequently, the signal processing apparatus 100 detects the motion vector of the target block on the basis of a position (coordinates) of the partial region within the target frame, and a position (coordinates) of the coincidence region within the reference frame. Specifically, the signal processing apparatus 100 detects the motion vector of the target block on the basis of an amount of deviation between the position (coordinates) of the partial region and the position (coordinates) of the coincidence region.

### (Generation of Interpolating Frame)

Hereinafter, details of the above-mentioned generation of the interpolating frame will be described with reference to FIG. 11. FIG. 11 is a flowchart showing details of the above-mentioned generation of the interpolating frame.

As shown in FIG. 11, in step 61, the signal processing apparatus 100 sets a target pixel that is any one of plural pixels forming the interpolating frame. For example, the signal processing apparatus 100 sets an upper left pixel of the interpolating frame as the target pixel.

In step 62, within the target frame; the signal processing apparatus 100 firstly specifies a position (coordinates) corresponding to the target pixel. The signal processing apparatus 100 secondly acquires motion vectors of blocks provided around the position (coordinates) corresponding to the target pixel (hereinafter, such blocks are referred to as surrounding blocks). Here, the surrounding blocks include a block containing the position (coordinates) corresponding to the target pixel, and blocks neighboring that block. On the basis of the motion vectors of the surrounding blocks, the signal processing apparatus 100 thirdly acquires a motion vector applied to the target pixel.

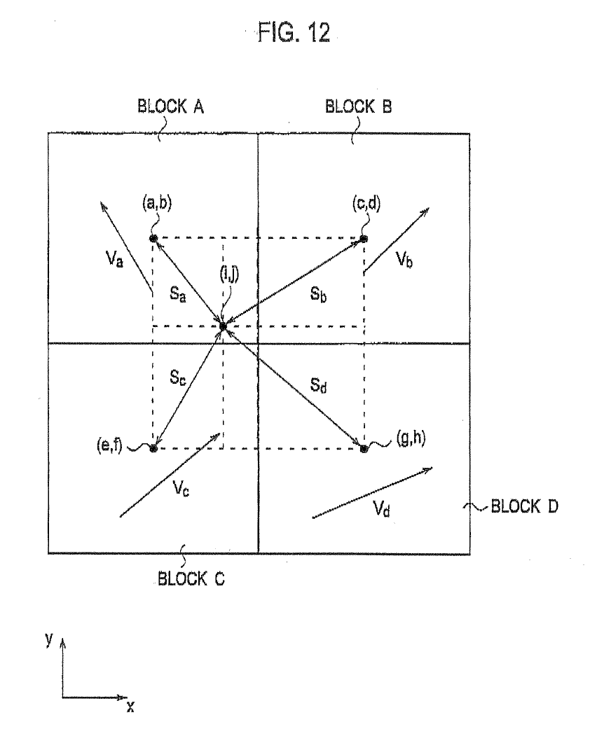

One example of an acquisition method of the motion vector applied to he target pixel will be described with reference to FIG. 12. In FIG. 12, a position of each pixel is denoted by coordinates (x, y). The position of the target pixel is coordinates (i, j).

The surrounding blocks are blocks A, B, C and D. A position of a central pixel of the block A is located at coordinates (a, b); a position of a central pixel of the block B, coordinates (c, a); a position of a central pixel of the block C, coordinates (e, f); and a position of a central pixel of the block D, coordinates (g, h). A motion vector of the block A is denoted by Vₐ; a motion vector of the block B, V_{b}; a motion vector of the block C, V_{c}; and a motion vector of the block D, V_{d}.

An area S is an area of a rectangular region having vertices at the coordinates (a, b), coordinates (c, d), coordinates (e, f) and coordinates (g, h). An area Sₐ is an area of a rectangular region whose diagonal ends at the coordinates (a, b) and coordinates i, j). An area S_{b} is an area of a rectangular region whose diagonal ends at the coordinates (c, d) and coordinates (i, j). An area S_{c} is an area of a rectangular region whose diagonal ends at the coordinates (e, f) and coordinates (i, j). An area S_{d} is an area of a rectangular region whose diagonal ends at the coordinates (g, h) and coordinates (i, j).

In such a case, the motion vector applied to the target pixel is acquired on the basis of the motion vectors of the surrounding blocks; and distances from the target pixel to the central pixels of the respective surrounding blocks. For example, the motion vector (Vₚ) applied to the target pixel is calculated by Vₚ=(Vₐ×S_{d}+V_{b}×S_{c}+V_{c}×S_{b}+V_{d}×Sₐ)/S.

In step 63, the signal processing apparatus 100 acquires a pixel Pb from the target frame on the basis of the motion vector (Vₚ). Specifically, from the target frame, the signal processing apparatus 100 acquires the pixel Pb whose coordinates are located at “−Vₚ/2” relative to the coordinates (i, j) of the target pixel.

In step 64, the signal processing apparatus 100 acquires a pixel Pr from the reference frame on the basis of the motion vector (Vₚ). Specifically, from the reference frame, the signal processing apparatus 100 acquires the pixel Pr whose coordinates are located at “Vₚ/2” relative to the coordinates i, j) of the target pixel.

In step 65, the signal processing apparatus 100 positions the target pixel P. Specifically, the signal processing apparatus 100 calculates the target pixel P by P=(Pb+Pr)/2.

In step 66, the signal processing apparatus 100 determines whether or not all of pixels forming the interpolating frame have been positioned The signal processing apparatus 100 proceeds to processing in step 67 if all of the pixels forming the interpolating frame have not yet been positioned. The signal processing apparatus 100 proceeds to processing in step 68 if all of the pixels forming the interpolating frame have been positioned.

In step 67, the signal processing apparatus 100 shifts the target pixel within the interpolating frame. In other words, the signal processing apparatus 100 sequentially shifts the target pixel from one pixel to another.

In step 68, the signal processing apparatus 100 generates the interpolating frame formed of plural pixels. In other words, the signal processing apparatus 100 generates the interpolating frame formed of the pixels determined in step 65.

### (Advantages and Effects)

In the first embodiment, the comparing unit 44 specifies the coincidence region that is the search region having the highest degree of coincidence with the partial region. The detecting unit 45 detects the motion vector of the target block on the basis of a position of the partial region within the target frame, and a position of the coincidence region within the reference frame. The partial region is a part of the target block.

Therefore, the number of pixels compared in calculating the degrees of coincidence is reduced as compared to a case where all of the pixels forming the target block are compared with all of pixels forming a search block. Thereby, processing load reduction can be promoted. In addition, processing load reduction can be promoted without reducing the number of times that the search region is shifted from one region to another within the search range.

In the first embodiment, the specification unit 41 includes the candidate-region shifting unit 41a and the determining unit 41b. The candidate-region shifting unit 41a sequentially shifts the candidate region from one region to another within the target block. As the candidate region is shifted, the determining unit 41b determines whether or not to specify the candidate region as the partial regions on the basis of the pixels forming four pixels of the candidate region.

Therefore, while promoting processing load reduction, the specification unit 41 can specify, as the partial region, a distinctive region having a change in luminance. Thereby, accuracy in detecting the motion vector of the target block is enhanced.

In the first embodiment, on the basis of a history of the motion vector of the target block, the determining unit 41b selects, from pixels forming four pixels of the candidate region, pixels used in the determination processing. In other words, the pixels used in the specification of the partial region are selected in accordance with an amount of shifting of an object image contained in a video.

Therefore, while promoting processing load reduction, the specification unit 41 can specify, as the partial region, a distinctive region having a change in luminance. Thereby, accuracy in detecting the motion vector of the target block is enhanced.

In the first embodiment, on the basis of a variance of plural pixels forming the candidate region, the determining unit 41b determines whether or not to specify the candidate region as the partial region.

Therefore, the specification unit 41 can specify as the partial region, a distinctive region having a change in luminance. Thereby, accuracy it detecting the motion vector of the target block is further enhanced.

### [Other Embodiments]

While the present invention has been described by use of the above embodiment, it should not be understood that the descriptions and the drawings forming parts of this disclosure limit the present invention. From this disclosure, various alternative embodiments, examples, and operational technologies will be apparent to those skilled in the art.

For example, the calculation method for the score (S) of the candidate region is not limited to the score calculation methods 1 to 3. Specifically, the score (S) of the candidate region may be calculated on the basis of an arbitrary pixel after the arbitrary pixel is selected from the candidate region.

Although the setting unit 42 configured to set the search range within the reference frame is provided in the above embodiment, the setting up of the search range is not essential.

Although the specification unit 41 includes the candidate-region shifting unit 41a and the determining unit 41b in the above embodiment, a configuration of the specification unit 41 is not limited to that configuration. The specification unit 41 may specify the partial region by another method as long as the specification unit 41 specifies the partial region by using plural pixels forming the target block.

The signal processing apparatus 100 may be applied to a display apparatus such as a projection display apparatus, a digital television, a mobile phone, or the like.

What is claimed is:

1. A signal processing apparatus which detects a motion vector of a target block on the basis of a target frame formed of a plurality of blocks, and a reference frame referred to in detecting a motion vector, the target block being any one of the blocks, the signal processing apparatus comprising:
a specification unit configured to specify a partial region on the basis of a plurality of pixels forming the target block, the partial region being a part of the target block;
a search-region shifting unit configured to sequentially shift a search region from one region to another within the reference frame, the search region being to be compared with the partial region;
a comparing unit configured to calculate a degree of coincidence of the search region with the partial region, and to specify a coincidence region which is the search region having the highest degree of coincidence with the partial region; and
a detecting unit configured to detect the motion vector of the target block on the basis of a position of the partial region within the target frame, and a position of the coincidence region within the reference frame.

2. The signal processing apparatus according to claim 1, further comprising a setting unit configured to set a search range within the reference frame on the basis of a position of the target block within the target frame,
wherein the search-region shifting unit sequentially shifts the search region from one region to another within the search range.

3. The signal processing apparatus according to claim 1, wherein the specification unit includes:
a candidate-region shifting unit configured to sequentially shift a candidate region from one region to another within the target block, the candidate region being a candidate for the partial region; and
a determining unit configured to perform determination processing for determining whether or not to specify the candidate region as the partial region on the basis of pixels forming four corners of the candidate region, as the candidate region is shifted.

4. The signal processing apparatus according to claim 3, wherein, the determining it selects pixels to be used in the determination processing from the pixels forming the four corners of the candidate region, on the basis of a history of the motion vector of the target block.

5. The signal processing apparatus according to claim 1, wherein the specification unit includes:
a candidate-region shifting unit configured to sequentially shift a candidate region from one region to another within the target block, the candidate region being a candidate for the partial region; and
a determining unit configured to perform determination processing for determining whether or not to specify the candidate region as the partial region on the basis of a variance for a plurality of pixels forming the candidate region, as the candidate region is shifted.

6. A projection display apparatus comprising: the signal processing apparatus according to claim 1.
